(19) United States
(12) Patent Application Publication
(10) Pub. No.: US 2009/0122451 A1
(43) Pub. Date: May 14, 2009

(54) ESD PROTECTION CIRCUIT DEVICE

(76) Inventors: Meng-Yong Lin, Hsinchu City (TW); Bo-Chang Wu, Taichung County (TW); Wei-Yang Ou, Kao-Hsiung City (TW); Chi-Mo Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/936,803

(22) Filed: Nov. 8, 2007

(51) Int. Cl. H02H 9/00

(52) U.S. Cl. 361/56

(57) ABSTRACT

The present invention discloses an ESD (ELECTRO-STATIC DISCHARGE) protection circuit device, the ESD (ELECTRO-STATIC DISCHARGE) protection circuit device includes a first switching device having a first terminal coupled to a first signal; a first control device coupled to the first signal for generating a first control signal according to the first signal; a second switching device having a first terminal coupled to a second signal, a second terminal coupled to a second terminal of the first switching device; and a second control device coupled to the second signal and a control terminal of the first switching device for generating a second control signal according to the second signal; wherein the first control signal coupled to the control terminal of the second switching device, and the second control signal coupled to the control terminal of the first switching device.

### BACKGROUND OF THE INVENTION

1. Field of the Invention

The present invention is related to an electrostatic discharge (ESD) protection circuit device, and more particularly, to a device using transistor components to provide ESD protection between two different voltage sources.

2. Description of the Prior Art

Please refer to FIG. 1. FIG. 1 is a diagram illustrating a conventional ESD protection circuit 10 according to the prior art. The ESD protection circuit 10 comprises a first group of cascaded diodes 11 and a second group of cascaded diodes 12. The first group of cascaded diodes 11 is coupled to a first power source terminal N1 and a second power source terminal N2; the first source terminal N1 is implemented for receiving a first source voltage Vdd1 and the second source terminal N2 is implemented for receiving a second source voltage Vdd2. Similarly, the second group of cascaded diodes 12 is also coupled to the first power source terminal N1 and the second power source terminal N2. The difference between the first group of cascaded diodes 11 and second group of cascaded diodes 12 is that, provided the first source voltage Vdd1 and the second source voltage Vdd2 under normal operations meets the inequality: Vdd2>Vdd1, the first group of cascaded diodes 11 are forward biased, while the second group of cascaded diodes 12 are reversely biased. When there is an ESD pulse induced at one power source terminal, for example, the first power source terminal N1, the second group of cascaded diodes 12 will be turned on and will synchronously boost the voltage levels at the first power source terminal N1 and the second power source terminal N2 respectively according to amplitude of the ESD pulse. Oppositely, when the ESD pulse is induced at the second power source terminal N2, the first group of cascaded diodes 11 will be turned on and will simultaneously boost the voltage levels at the first power source terminal N1 and the second power source terminal N2 respectively according to amplitude of the ESD pulse. In this way, huge voltage differences will not be generated in the circuit system from the first source voltage Vdd1 and the second source voltage Vdd2, and the damage to components within the circuit system is avoided accordingly.

However, the conventional ESD protection circuit 10 has at least two problems. First, when the voltage difference between the desired first source voltage Vdd1 and the desired second source voltage Vdd2 is too large, it will require the diode numbers of both the first group of cascaded diodes 11 and second group of cascaded diodes 12 to be increased appropriately, but too many diodes will result in a slower response speed of the conventional ESD protection circuit 10. As a result, the conventional ESD protection circuit 10 is unable to respectively boost the voltage levels at the first power source terminal N1 and the second power source terminal N2 in time, to protect the circuit system. Second, in actual implementation, the first source voltage Vdd1 and the second source voltage Vdd2 are two independent voltage sources. Therefore, when both the first source voltage Vdd1 and the second source voltage Vdd2 are not enabled or disabled synchronously, it will cause huge forward turn-on current either in the first group of cascaded diodes 11 or in the second group of cascaded diodes 12, and hence the forward turn-on current will easily damage components within the circuit system.

### SUMMARY OF THE INVENTION

It is therefore one of the objectives of the present invention to provide an ESD protection circuit device utilizing transistor components to provide ESD protection between two different source voltages.

According to one aspect of the present invention, an ESD protection circuit device is disclosed. The ESD protection circuit device comprises a first switching component, a first control component, a second switching component and a second control component. The first switching component has a first terminal coupled to a first signal. The first control component is coupled to the first signal and is utilized for generating a first control signal according to the first signal. The second switching component has a first terminal coupled to a second signal, and a second terminal coupled to a second terminal of the first switching component. The second control component is coupled to the second signal and a control terminal of the first switching component, and is utilized for generating a second control signal according to the second signal. The first control signal is coupled to the control terminal of the second switching component, and the second control signal is coupled to the control terminal of the first switching component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional ESD protection circuit according to the prior art.

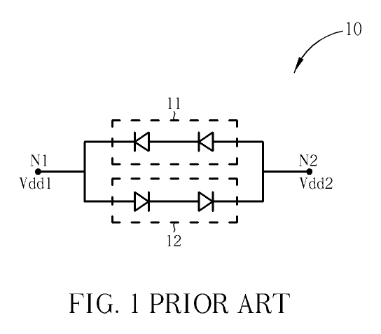

FIG. 2 is a diagram illustrating an exemplary embodiment of an ESD protection circuit device according to the present invention.

FIG. 3 is a diagram illustrating the ESD protection circuit device shown in FIG. 2 that operates under a DC supply mode.

FIG. 4 is a diagram illustrating the ESD protection circuit device shown in FIG. 2 that operates under an ESD protection mode.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

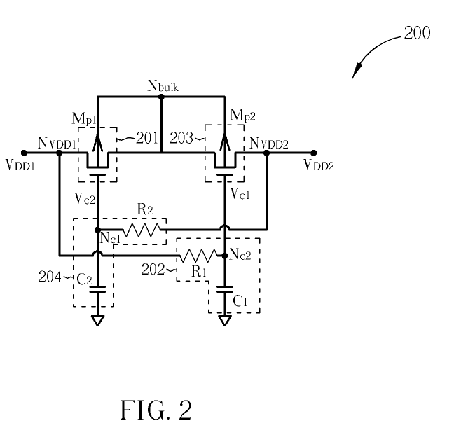

Please refer to FIG. 2. FIG. 2 is a diagram illustrating an exemplary embodiment of an ESD protection circuit device 200 according to the present invention. The ESD protection circuit device 200 comprises a first switching component 201, a first control component 202, a second switching component 203, and a second control component 204. In this exemplary embodiment, the ESD protection circuit device 200 is implemented for providing an ESD protection mechanism between a first power source terminal N_{VDD1} and a second power source terminal N_{VDD2}. The first power source terminal N_{VDD1} is implemented for receiving a first source voltage V_{DD1} and the second power source terminal N_{VDD2} is implemented for receiving a second source voltage V_{DD2}, where the first source voltage V_{DD1} is not equal to the second source voltage V_{DD2}. Consequently, when the ESD protection circuit device 200 of the present invention operates under a normal mode, a first terminal of the first switching component 201 (i.e., the first power source terminal N_{VDD1}) receives the first source voltage V_{DD1}; the first control component 202 is coupled to the first power source terminal N_{VDD1} and a control terminal N_{C2} of the second switching component 203 for generating a first control signal V_{C1}; the second switching component 203 has a first terminal (i.e., the second power source terminal N_{VDD2}) receives the second source voltage V_{DD2} and a second terminal coupled to a second terminal of the first switching component 201 (i.e., N_{bulk}). The second control component 204 is coupled to both the second source voltage V_{DD2} and a control terminal N_{c1} of the first switching component 201 for generating a second control signal V_{c2} according to the second source voltage V_{DD2}. The first control signal V_{C1} is coupled to the control terminal N_{C2} of the first control component 202, and the second control signal V_{C2} is coupled to the control terminal N_{C1} of the second control component 204. In another aspect, to better describe features of the present invention, in the ESD protection circuit device 200 of the prevent invention, the first switching component 201 is a first P-Channel FET (Field Effect Transistor) M_{P1}, and the control terminal N_{C1} of the first switching component 201 is a gate of the first P-Channel FET M_{P1}; the second switching component 203 is a second P-Channel FET M_{P2}, and the control terminal N_{C2} of second switching component 203 is a gate of the first P-Channel FET M_{P2}. Please note that, with proper modifications to the ESD protection circuit device 200 of the prevent invention, persons skilled in this art can easily implement both the first switching component 201 and the second switching component 203 by using N-Channel FETs. In yet another aspect, the first control component 202 is a first filter, which is consisted of a capacitor C₁ and a resistor R₁, for generating the first control signal V_{C1} by filtering the first voltage source V_{DD1}; and the second control component 204 is a second filter, which is consisted of a capacitor C₂ and a resistor R₂, for generating the second control signal V_{C2} by filtering the second voltage source V_{DD2}. Here please note that both the first filter and the second filter are low-pass filters, wherein a substrate of the first P-Channel FET M_{P1} is coupled to the second terminal N_{bulk} of the first P-Channel FET M_{P1}, and a substrate of the second P-Channel FET M_{P2} is coupled to the second terminal N_{bulk} of the second P-Channel FET M_{P2}. Simultaneously, both the substrate of the first P-Channel FET M_{P1} and the substrate of the second P-Channel FET M_{P2} are floating, as shown in FIG. 2.

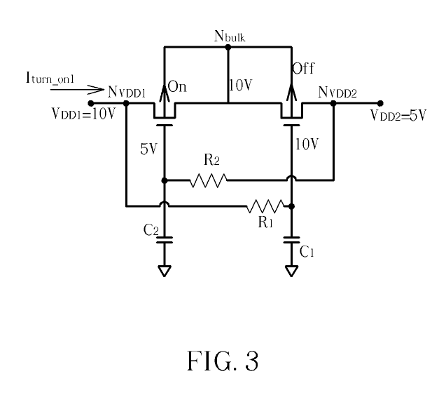

According to the ESD protection circuit device 200 of the prevent invention, the operations thereof can be divided into a direct current (DC) supply mode and an ESD protection mode. Please refer to FIG. 3. FIG. 3 is a diagram illustrating the ESD protection circuit device 200 shown in FIG. 2 that operates under the DC supply mode. For describing the present invention in further detail, the first source voltage V_{DD1} is set higher than the second source voltage V_{DD2}. For instance, V_{DD1}=10V and V_{DD2}=5V. Therefore, when V_{DD1}=10V, the control terminal N_{C2} of the second P-Channel FET M_{P2} is charged to 10V (i.e., the first control signal V_{C1}) and when V_{DD2}=5V, the control terminal N_{C1} of the first P-Channel FET M_{P1} is charged to 5V (i.e., the second control signal V_{C2}). Therefore, the first P-Channel FET M_{P1} is turned on to generate a turn-on current Iₜᵤᵣₙ_{_{—}}ₒₙ₁ which charges the second terminal N_{bulk} of the first P-Channel FET M_{P1} until the voltage level at the second terminal N_{bulk} reaches 10 V. In this manner, the second p-channel FET M_{P2} will be turned off. From the above description, when the ESD protection circuit device 200 operates under the DC supply mode, the first source voltage V_{DD1} is not electrically connected to the second source voltage V_{DD2}. On the other hand, when the first source voltage V_{DD1} is set lower than the second source voltage V_{DD2}: for instance, V_{DD1}=5 V and VDD₂=10 V, the second P-Channel FET M_{P2} is on, while the first P-Channel FET M_{P1} is off. Therefore, under the DC supply mode, the first source voltage V_{DD1} and the second source voltage V_{DD2} can provide voltage sources to respective circuits normally

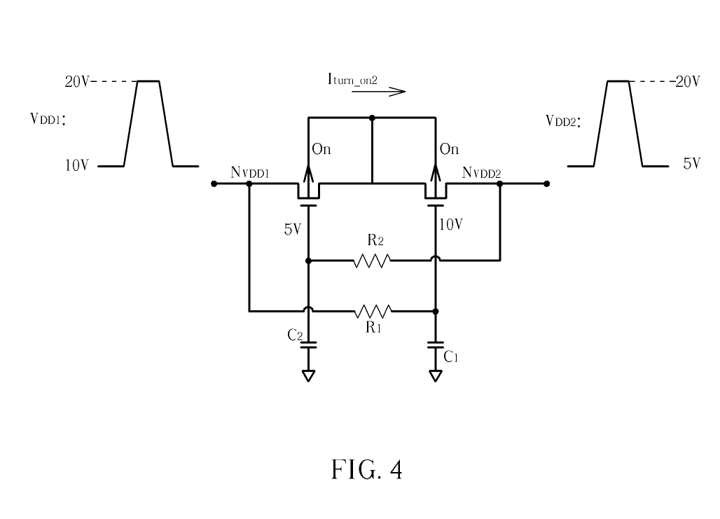

Please refer to FIG. 4. FIG. 4 is a diagram illustrating the ESD protection circuit device 200 shown in FIG. 2 that operates under the ESD protection mode. For describing the present invention in further detail, the ESD protection circuit device 200 initially operates under the DC supply mode: for example, the first source voltage V_{DD1} is 10V and the second source voltage V_{DD2} is 5V. When there is an ESD pulse at the first source voltage V_{DD1} of the first power source terminal N_{VDD1}, the ESD pulse immediately increases the voltage level at the first source voltage V_{DD1} to exceed the normal voltage value 10V. For instance, when the ESD pulse is a 10V transient pulse, the first source voltage V_{DD1} of the first power source terminal N_{VDD1} will be boosted to 20V, as shown in FIG. 4. Because the first P-Channel FET M_{P1} is initially on, the first P-Channel FET M_{P1} therefore generates a turn-on current Iₜᵤᵣₙ_{_{—}}ₒₙ₂ flowing to the second terminal N_{bulk} of the first P-Channel FET M_{P1}. Please note that, because the second terminal N_{bulk} of the first P-Channel FET M_{P1} has been charged to 10V under the DC supply mode, the turn-on current Iₜᵤᵣₙ_{_{—}}ₒₙ₂ immediately turns on the second P-Channel FET M_{P2}. Please also note that in the meanwhile, the first filter makes the control terminal N_{C2} of the second P-Channel FET M_{P2} (i.e., the first control signal V_{C1}) temporarily stay at 10V. For this reason, the second P-Channel FET M_{P2} is turned on and allows the turn-on current Iₜᵤᵣₙ_{_{—}}ₒₙ₂ to flow to the second power source terminal N_{VDD2}. As a result, the ESD pulse is guided to the second power source terminal N_{VDD2}. In this manner, the second source voltage V_{DD2} of the second power source terminal N_{VDD2} is raised from the original 5V to 20V. Here, it should be noted that when the ESD pulse is guided to the second power source terminal N_{VDD2}, the second filter makes the control terminal N_{C1} of the first P-Channel FET M_{P1} (i.e., the second control signal V_{C2}) temporarily maintain at 5V, allowing the second P-Channel FET M_{P2} to be conductive until the ESD pulse vanishes. From the above description, when the exemplary embodiment of the ESD protection circuit device 200 according to the present invention operates under the ESD protection mode, voltage levels at the first source voltage V_{DD1} and the second source voltage V_{DD2} are increased respectively and synchronously according the amplitude of the ESD pulse, preventing circuits corresponding to the first source voltage V_{DD1} and the second source voltage V_{DD2}, respectively, from electrostatic interference and allowing the circuits to work normally. On the other hand, when there is an ESD pulse at the second source voltage V_{DD2} of the second power source terminal N_{VDD2}, a similar flow is executed to discharge the ESD pulse. As a skilled person can readily understand the operation and function of the ESD protection circuit device of the present invention after reading the above-mentioned disclosure, further description is omitted here for brevity.

Besides, owing to one of two P-Channel FETs in the ESD protection circuit device 200 must be off when the ESD protection circuit device 200 of the present invention operates under the DC supply mode. In a case that the first source voltage V_{DD1} and the second source voltage V_{DD2} do not disable simultaneously and results in the huge forward current generated between the first source voltage V_{DD1} and the second source voltage V_{DD2} is not able to deliver between the first power source terminal N_{VDD1} and the second power source terminal N_{VDD2}. In this manner, the circuits respectively corresponding to the first source voltage V_{DD1} and the second source voltage V_{DD2} hence avoid to be damaged by the huge forward current. On the contrary, both the first P-Channel FET M_{P1} and the second P-Channel FET M_{P2} in the ESD protection circuit device 200 are off when the ESD protection circuit device 200 of the present invention disables. Further more, at this time, the sharing second terminal N_{bulk} of the second P-Channel FET M_{P1} and the second P-Channel FET M_{P2} is uncharged, it is to say the second terminal N_{bulk} is 0 voltage. By utilizing the aforementioned apparatus of the present invention, if the first source voltage V_{DD1} and the second source voltage V_{DD2} do not turn on simultaneously; the huge forward turn-on current generated between the first source voltage V_{DD1} and the second source voltage V_{DD2} has firstly to charge the second terminal N_{bulk} and therefore makes the huge forward current is not able to deliver to another terminal transiently. The circuits respectively corresponding to the first source voltage V_{DD1} and the second source voltage V_{DD2} hence avoid to be damaged by the huge forward current.

Those skilled in the art will readily observe that numerous modifications and alterations of the device and method may be made while retaining the teachings of the invention.

What is claimed is:

1. An electrostatic discharge (ESD) protection circuit device, comprising:
a first switching component, having a first terminal coupled to a first signal;
a first control component, coupled to the first signal, for generating a first control signal according to the first signal;
a second switching component, having a first terminal coupled to a second signal, a second terminal coupled to a second terminal of the first switching component, and a control terminal coupled to the first control component; and
a second control component, coupled to the second signal and a control terminal of the first switching component, for generating a second control signal according to the second signal;
wherein the first control signal is coupled to the control terminal of the second switching component, and the second control signal is coupled to the control terminal of the first switching component.

2. The ESD protection circuit device of claim 1, wherein the first switching component is a first transistor, and the control terminal of the first switching component is a gate of the transistor; the second switching component is a second transistor, and the control terminal of the second switching component is a gate of the second transistor; the first control component is a first filter utilized for filtering the first signal to generate the first control signal; and the second control component is a second filter utilized for filtering the second signal to generate the second control signal.

3. The ESD protection circuit device of claim 2, wherein a substrate of the first transistor is coupled to the second terminal of the first transistor, and a substrate of the second transistor is coupled to the second terminal of the second transistor.

4. The ESD protection circuit device of claim 2, wherein the substrate of the first transistor and the substrate of the second transistor are both floating.

5. The ESD protection circuit device of claim 2, wherein the first transistor and the second transistor are P-channel Field Effect Transistors.

6. The ESD protection circuit device of claim 2, wherein the first transistor and the second transistor are N-channel Field Effect Transistors.

7. The ESD protection circuit device of claim 2, wherein the first filter and the second filter are low-pass filters.

8. The ESD protection circuit device of claim 1, wherein the first signal and the second signal are power source signals with different voltage levels.
